(19) United States
(12) Patent Application Publication
(10) Pub. No.: US 2007/0171307 A1
(43) Pub. Date: Jul. 26, 2007

(54) Media playback system with real-time camera image display and method thereof

(75) Inventor: Wen-Wei Tsai, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/657,610

(22) Filed: Jan. 25, 2007

(30) Foreign Application Priority Data
Jan. 26, 2006 (TW) 095103151

(51) Int. Cl. H04N 5/45

(52) U.S. Cl. 348/565

(57) ABSTRACT

The invention relates to a media playback system having a real-time displaying capability of displaying images generated from a camera and method thereof The media playback system receives a first input signal, and includes a real-time communication device for generating a second input signal, a playback processor, electrically coupled to the real-time communication device, for generating an output signal by integrating the first and second input signals, and a displaying device, coupled to the playback processor, for playing the output signal according to a first command.

### BACKGROUND OF THE INVENTION

1. Field of the Invention

The present invention relates to a media playback system with real-time displaying capability and method thereof, and more particularly, to a media playback system capable of receiving at least two input signals simultaneously and method thereof.

2. Description of the Prior Art

Televisions and related peripheral devices and systems have become necessary household appliances in recent times. These modern devices and systems include functions such as: a time switch setting for automatic power-on, preset recording of a specified program, and picture out picture (POP) display. Also, other systems including similar functions are becoming more and more popular. For example, a television (TV) set-top box is used for watching cable TV programs on a computer, and a home theater apparatus is used for simulating a comfortable entertainment environment commensurate with traditional theaters by using a projector and a stereo or multi-channel audio playback apparatus. Thus, it is apparent that watching TV programs has become one of the most popular entertainment options available in our modern society.

However, there are very often any numbers of disturbances that can interrupt the otherwise pleasant experience of enjoying TV watching. For example, it is common that a phone call or a doorbell ringing will occur while a user is watching TV programs. As is well know, the viewer will miss some of the TV programming because the TV program cannot be paused.

### SUMMARY OF THE INVENTION

Thus, an objective of the present invention is to provide a media playback system and method thereof to solve above-mentioned problems.

According to an embodiment of the claimed invention, a media playback system having a real-time displaying capability of displaying images generated from a camera is disclosed. The media playback system receives a first input signal, and includes a real-time communication device for generating a second input signal, a playback processor, electrically coupled to the real-time communication device, for generating an output signal by integrating the first and second input signals, and a displaying device, coupled to the playback processor, for playing the output signal according to a first command.

According to an embodiment of the claimed invention, a media playback method having a real-time displaying capability of displaying images generated from a camera is also disclosed. The media playback method receives a first input signal, and includes: utilizing a real-time communication device to generate a second input signal; generating an output signal by integrating the first and second input signals; and displaying the output signal according to a first command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a media playback system according to a preferred embodiment of the present invention.

FIG. 2 is a flow chart of a media playback method according to a preferred embodiment of the present invention.

### DETAILED DESCRIPTION

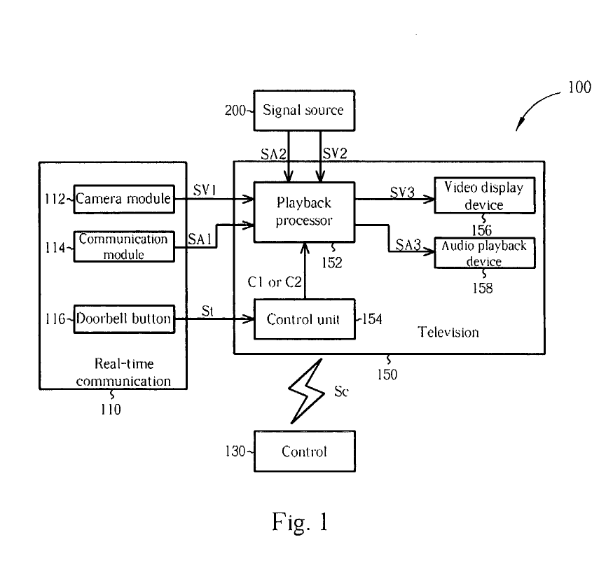

Please refer to FIG. 1. FIG. 1 is a block diagram illustrating a media playback system 100 according to a preferred embodiment of the present invention. In this embodiment, the media playback system 100 includes a real-time communication device 110, a television 150, and a remote control 130, where the television 150 is coupled to a signal source 200. Additionally, the real-time communication device 110 is a doorbell device including a camera module 112, a communication module 114, and a doorbell button 116. The television 150 includes a playback processor 152, a control unit 154, a video display device 156, and an audio playback device 158.

If a user utilizes the television 150 to watch TV programs and the real-time communication device 110 has no action triggered, the playback processor 152 directly processes an audio signal SA2 and a video signal SV2 to generate an audio signal SA3 and a video signal SV3, and then sends the audio signal SA3 and the video signal SV3 to the video display device 156, such as a TV screen, and to the audio playback device 158, such as TV speakers, respectively. In this way, the user can watch the images corresponding to the video signal SV3 and listen to the sound corresponding to the audio signal SA3.

However, the door ring button 116 sends a trigger signal St to the control unit 154 while an outdoor visitor pushes the doorbell button 116, and the camera module 112 is activated as well as the communication module 114. After receiving the trigger signal St, the control unit 154 sends a command C1 to drive the playback processor 152 to add a text message to the video signal SV3 or a notification audio clip to the audio signal SA3 to inform the user that there is a visitor. If the user wants to know who the visitor is, he can use the user interface on the remote control 130 to send a control signal Sc to the control unit 154, and the control unit 154 transmits a command C2 to the playback processor 152 to drive the playback processor 152 to integrate the video signal SV1 generated from the camera module 112 and the video signal SV2 from the signal source 200 to generate the video signal SV3. At this moment, the video display device 156 displays the video signal SV3 in the form of picture in picture (PIP) or picture out picture (POP), and the user can check the visitor at the same time when watching the TV programs.

Furthermore, the user may even talk to the visitor if the communication module 114 has a built-in high-sensitive microphone. Also, the user can use the remote control 130 to send the control signal Sc to the control unit 154 wirelessly to drive the playback processor 152, and the playback processor 152 generates the audio signal SA3 according to the audio signal SA1 from the communication module 114. In this case, the user hears the voice of the outdoor visitor instead of the sound of the currently selected TV program. Alternatively, the playback processor 152 directly integrates the audio signal SA1 and the audio signal SA2 to generate the audio signal SA3, such that the user can hear the voice of the visitor and the sound of the currently selected TV program simultaneously and talk with the visitor by the built-in high-sensitive microphone. In other words, the user to adjust the operation mode of the playback processor 152 to determine whether the user can hear sound from one or two video signals as well as viewing image(s) from one or two video signals at the same time.

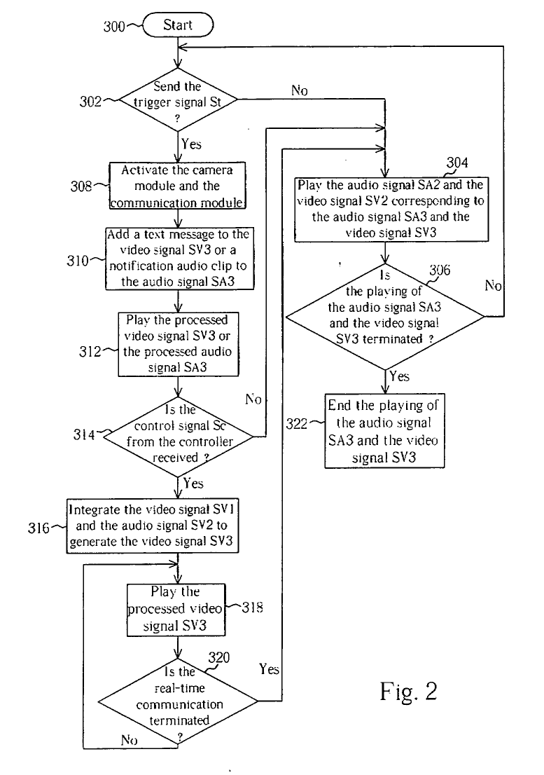

Please refer to FIG. 2. FIG. 2 is a flow chart of a media playback method according to a preferred embodiment of the present invention. This method is applied to the media playback system 100 shown in FIG. 1, and comprises the steps as detailed below:
Step 300: Start
Step 302: Detect if the doorbell 116 sends the trigger signal St? If yes, go to step 304; otherwise, go to step 308.
Step 304: Play the audio signal SA2 and the video signal SV2 corresponding to the audio signal SA3 and the video signal SV3.
Step 306: Is the playing of the audio signal SA3 and the video signal SV3 terminated? If yes, go to step 322; otherwise, go back to step 302 to continue monitoring the trigger signal St.
Step 308: Activate the camera module 112 and the communication module 114.
Step 310: Send a command C1 to drive the playback processor 152 to add a text message to the video signal SV3 or a notification audio clip to the audio signal SA3.
Step 312: Play the processed video signal SV3 or the processed audio signal SA3 to inform the user.
Step 314: Detect if the control signal Sc from the controller is received. If yes, go to step 316; otherwise, go to step 304.
Step 316: Output a command C2 to drive the playback processor 152 to integrate the video signal SV1 and the audio signal SV2 to generate the video signal SV3.
Step 318: Play the processed video signal SV3 to allow the user to identify the visitor.
Step 320: Is the real-time communication terminated? If yes, go to step 304; otherwise, go back to step 318.
Step 322: End the playing of the audio signal SA3 and the video signal SV3.

Since the detail operation of the media playback system 100 has been mentioned above, further description of the media playback method is omitted for the sake of brevity. Also, the steps of the media playback method are not limited to the order of the steps described in FIG. 2 if the achieved result is substantially the same.

Additionally, it should be noted that the real-time communication device 110 is not limited to the television screen intercom example provided herein. The real-time communication device 110 can be any device capable of generating the video signal or the audio signal in a real-time fashion, such as a traditional telephone or video telephone. Additionally, the media playback system of the embodiment of the present invention can be applied to a television as offered as an example herein as well as other audio/video playback devices such as but not limited to: personal computers, projectors, and audio devices. By this way, the user can perform other jobs and tasks while listening to or watching TV programs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A media playback system having a real-time displaying capability of displaying images generated from a camera, the media playback system receiving a first input signal and comprising:
a real-time communication device, for generating a second input signal;
a playback processor, electrically coupled to the real-time communication device, for generating an output signal by integrating the first and the second input signals; and
a video display device, coupled to the playing processor, for playing the output signal according to a first command.

2. The system of claim 1, further comprising:
a control unit, coupled to the playing processor, for outputting the first command;
wherein the playing processor generates the output signal by integrating the first and second input signals while receiving the first command, and does not generate the output signal according to the second input signal while the first command is not received.

3. The system of claim 1, wherein the real-time communication device comprises:
a camera module, for generating an video signal of the first input signal;
a communication module, coupled to the camera module, for generating an audio signal of the first input signal; and
a doorbell button, coupled to the communication module, for transmitting a trigger signal.

4. The system of claim 3, further comprises:
a remote control, for transmitting a control signal to the control unit wirelessly;
wherein the control unit outputs the first command after receiving the trigger signal and the control signal.

5. The system of claim 3, wherein the control unit sends a second command to the playing processor to add notification information to the output signal after receiving the trigger signal and before outputting the first command.

6. The system of claim 1, wherein the displaying device is positioned in a television, a computer, or a projector.

7. The system of claim 1, wherein the real-time communication device is a video telephone or a television screen intercom.

8. A media playback method having a real-time displaying capability of displaying images generated from a camera, the media playback method receiving a first input signal and comprising:
utilizing a real-time communication device to generate a second input signal;
generating an output signal by integrating the first and second input signals; and
playing the output signal according to a first command.

9. The method of claim 8, further comprising:
when the first command is not received, generating the output signal according to the first input signal only.

10. The method of claim 8, further comprising:
transmitting a trigger signal utilizing the real-time communication device;
transmitting a control signal wirelessly; and
generating the first command after receiving the trigger signal and the control signal.

11. The method of claim 10, further comprising: adding notification information to the output signal before generating the first command according to the trigger signal.

12. The method of claim 8, wherein the first input signal includes at least a video signal.

13. The method of claim 12, wherein the output signal is played on a television, a computer, or a projector.

14. The method of claim 8, wherein the second input signal includes at least an audio signal.

15. The method of claim 8, wherein the real-time communication device is a video telephone or a television screen intercom.
